(19) United States
(12) Patent Application Publication
(10) Pub. No.: US 2014/0125861 A1
(43) Pub. Date: May 8, 2014

(54) IMAGING APPARATUS AND METHOD FOR CONTROLLING SAME

(71) Applicant: CANON KABUSHIKI KAISHA, Tokyo (JP)

(72) Inventors: Kazuhiko Sugie, Yokohama-shi (JP); Tomoya Yamashita, Yokohama-shi (JP); Hiroyasu Morita, Kawasaki-shi (JP); Shinji Hisamoto, Yokohama-shi (JP)

(73) Assignee: CANON KABUSHIKI KAISHA, Tokyo (JP)

(21) Appl. No.: 14/067,391

(22) Filed: Oct. 30, 2013

(30) Foreign Application Priority Data
Nov. 7, 2012 (JP) 2012-245309
Nov. 12, 2012 (JP) 2012-248657
Nov. 20, 2012 (JP) 2012-254716
May 13, 2013 (JP) 2013-101182

(51) Int. Cl. H04N 5/232; H04N 13/02

(52) U.S. Cl. CPC H04N 5/23203; H04N 13/0217
USPC 348/349

(57) ABSTRACT

An imaging apparatus including an imaging element that includes a pixel portion sets a first readout area and then performs detection processing for detecting the phase difference of an image signal read out from the area to thereby output the reliability of the phase difference. If the imaging apparatus determines that phase difference detection has been successful, the imaging apparatus executes focus adjustment processing based on the detected phase difference. If the imaging apparatus determines that the phase difference has failed to be detected, the imaging apparatus sets a second readout area having a range wider than that of the first readout area as a readout area, and then sets an area other than an area which is included in the first readout area from the second readout area and is used for generating a display image as a trimming target.

### BACKGROUND OF THE INVENTION

1. Field of the Invention

The present invention relates to an imaging apparatus and a method for controlling the same.

2. Description of the Related Art

There have been proposed technologies in which phase difference-type focus detection is performed by dividing a photodiode (PD) which light is collected with one micro lens in one pixel provided in an imaging element. Japanese Patent Laid-Open No. 2001-083407 discloses an imaging apparatus in which a photodiode in one pixel is divided into two parts and each of the divided photodiodes receives light from a different pupil plane of an imaging lens. The imaging apparatus compares outputs from the two photodiodes to thereby perform focus detection of the imaging lens.

There has also been proposed an imaging apparatus that has an imaging element capable of reading out a specific area and reads out an area smaller than the entire area of the imaging element to thereby have a function of zooming toward the telescopic side without using a zoom lens. Japanese Patent Laid-Open No. 2002-314868 discloses an imaging apparatus that performs control by combining electronic zooming and optical zooming to thereby realize a zoom range wider than that determined by either one of electronic zooming and optical zooming.

By applying the technologies disclosed in Japanese Patent Laid-Open No. 2001-083407 to the technologies disclosed in Japanese Patent Laid-Open No. 2002-314868, an imaging apparatus (hereinafter referred to as “imaging apparatus A”) that generates an image for zoom display by reading out the specific area of an imaging element and performs phase difference focus detection by utilizing a plurality of PDs included in one pixel is contemplated. A focus state (focused state or non-focused state) is also detected on the basis of the result of phase difference detection. A display area during zoom photographing is included in a specific area serving as a readout area for an image signal. However, the following circumstance may occur on the imaging apparatus A.

FIGS. 17A to 17C are diagrams illustrating operation processing performed by the imaging apparatus A. When PDs included in one pixel provided in an imaging apparatus are arranged two by two at left and right sides, two images, i.e., a left image and a right image are obtained from each PD. FIG. 17B is a diagram illustrating left image line data and right image line data.

Here, when the imaging apparatus A reads out the whole field angle of the imaging element as shown in FIG. 17A, a phase difference can be calculated by utilizing line data from the coordinates (X1, Y) to the coordinates (X4, Y) on the imaging element. However, when the imaging apparatus A reads out the specific area of the imaging element as shown in FIG. 17C, an area available for phase difference calculation is limited in the range from (X2, Y) to (X3, Y), resulting in a reduction in focus detection accuracy. When the readout position of the specific area of the imaging element is changed by a user in association with change in display area during zoom photographing, the focus state detection accuracy may also be reduced.

### SUMMARY OF THE INVENTION

The present invention provides an imaging apparatus that generates a display image and detects a phase difference based on an image signal read out from the readout area of an imaging element so as to prevent a reduction in focus detection accuracy based on the detected phase difference from being degraded. The present invention also provides an imaging apparatus that performs phase difference detection processing based on an image signal read out from the specific area of an imaging element and prevents a reduction in focus state detection accuracy upon changing a display position during zoom photographing.

According to an aspect of the present invention, an imaging apparatus is provided that includes an imaging element comprising a pixel portion having a plurality of photoelectric conversion units that are configured to generate an image signal by photoelectrically converting light fluxes having passed through different divided areas of an exit pupil of an imaging optical system with respect to one micro lens; a setting unit configured to set a first readout area as an area for reading out an image signal from the pixel portion; a detecting unit configured to perform detection processing for detecting a phase difference between a left image signal and a right image signal that are included in the image signal read out from the first readout area to thereby output the reliability of the phase difference; a determining unit configured to determine whether or not phase difference detection has been successful based on the reliability of the output phase difference; and an adjusting unit configured to execute focus adjustment processing based on the detected phase difference if it is determined that phase difference detection has been successful, wherein, if it is determined that the phase difference has failed to be detected, the setting unit sets a second readout area having a range wider than that of the first readout area as a readout area targeted for detection processing for detecting the next phase difference. The imaging apparatus further includes a trimming processing unit that is configured to perform trimming processing by setting an area other than an area which is included in the first readout area from the second readout area and is used for generating a display image as a trimming target.

According to the present invention, an imaging apparatus that generates a display image (e.g., an image for zoom display) and detects a phase difference based on an image signal read out from the readout area of an imaging element so as to prevent a reduction in focus detection accuracy based on the detected phase difference from being degraded may be provided. According to the present invention, an imaging apparatus that performs phase difference detection processing based on an image signal read out from the specific area of an imaging element so as to prevent a reduction in focus state detection accuracy upon changing a display position during zoom photographing may also be provided.

Further features of the present invention will become apparent from the following description of exemplary embodiments with reference to the attached drawings.

### BRIEF DESCRIPTION OF THE DRAWINGS

FIG. 1 is a diagram illustrating an exemplary configuration of an imaging apparatus according to the present embodiment.

FIGS. 2A and 2B are diagrams schematically illustrating an exemplary configuration of an imaging element.

FIG. 3 is a diagram illustrating an exemplary pixel array.

FIG. 4 is a conceptual diagram illustrating how a light flux emitted from the exit pupil of a photographing lens enters an imaging element.

FIG. 5 is a diagram illustrating an exemplary configuration of a video signal processing unit.

FIG. 6 is a flowchart illustrating an example of operation processing performed by an imaging apparatus according to a first embodiment.

FIGS. 7A and 7B are diagrams illustrating readout area settings.

FIG. 8 is a flowchart illustrating an example of operation processing performed by an imaging apparatus according to a second embodiment.

FIGS. 9A to 9E are diagrams illustrating readout area settings.

FIGS. 10A and 10B are diagrams illustrating readout area settings in an imaging apparatus according to a third embodiment.

FIG. 11 is a flowchart illustrating an example of operation processing performed by an imaging apparatus according to a fourth embodiment.

FIG. 12 is a diagram illustrating specific area settings.

FIGS. 13A and 13B are diagrams illustrating specific area settings.

FIG. 14 is a flowchart illustrating an example of operation processing performed by an imaging apparatus according to a fifth embodiment.

FIG. 15 is a flowchart illustrating an example of operation processing performed by an imaging apparatus according to a sixth embodiment.

FIGS. 16A and 16B are diagrams illustrating specific area settings.

FIGS. 17A to 17C are diagrams illustrating operation processing performed by an imaging apparatus.

### DESCRIPTION OF THE EMBODIMENTS

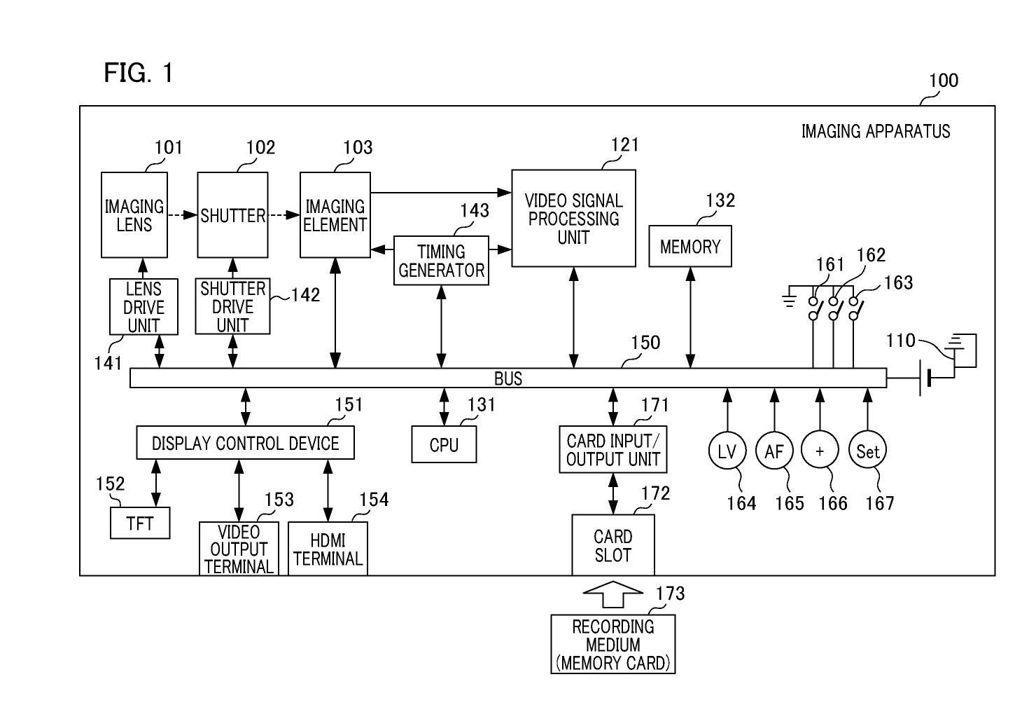

FIG. 1 is a diagram illustrating an exemplary configuration of an imaging apparatus of the present embodiment. Among the components provided in an imaging apparatus 100, a power source 110 supplies power to the circuits provided in the imaging apparatus 100. A card slot 172 is a slot into which a memory card (removable recording medium) 173 can be inserted. The memory card 173 is electrically connected to a card input/output unit 171 with the memory card 173 inserted into the card slot 172. Although, in the present embodiment, the memory card 173 is employed as a recording medium, other recording medium such as a hard disk, an optical disk, a magneto-optical disk, a magnetic disk or other solid memory may also be employed.

An imaging lens 101 focuses the optical image of an object on an imaging element 103. A lens drive unit 141 drives the imaging lens 101 to thereby execute zoom control, focus control, aperture control, and the like. A mechanical shutter 102 is driven by a shutter control unit 142 and executes exposure control.

The imaging element 103 is a photoelectric conversion unit constituted by a CMOS imaging element or the like. The imaging element 103 photoelectrically converts an object image formed by an imaging optical system having the imaging lens 101 and the shutter 102 to thereby output an image signal.

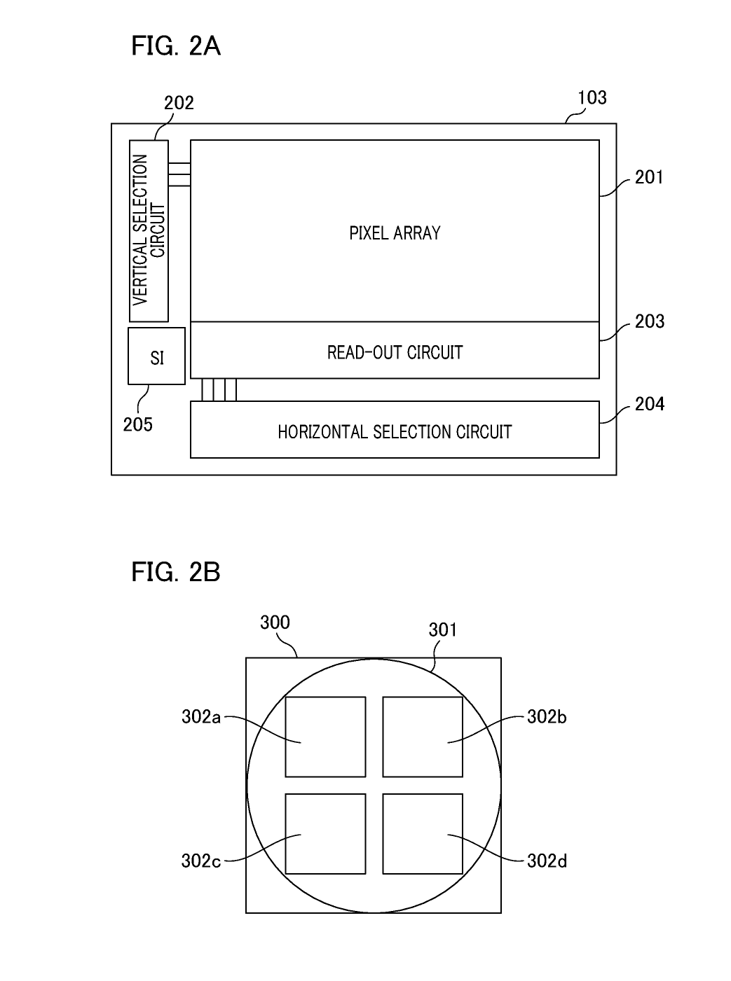

FIGS. 2A and 2B are diagrams schematically illustrating an exemplary configuration of an imaging element which is applied to the imaging apparatus of the present embodiment. FIG. 2A is a diagram illustrating the general configuration of an imaging element. The imaging element 103 includes a pixel array 201, a vertical selection circuit 202 that selects a row in the pixel array 201, and a horizontal selection circuit 204 that selects a column in the pixel array 201. A read-out circuit 203 reads a signal of a pixel portion selected from among the pixel portions in the pixel array 201 by the vertical selection circuit 202. The read-out circuit 203 has a memory for accumulating signals, a gain amplifier, an A (Analog)/D (Digital) converter, or the like for each column.

A serial interface (SI) unit 205 determines the operation mode of each circuit in accordance with the instructions given by a CPU 131. The vertical selection circuit 202 sequentially selects a plurality of rows of the pixel array 201 so that a pixel signal(s) is extracted to the read-out circuit 203. Also, the horizontal selection circuit 204 sequentially selects a plurality of pixel signals read by the read-out circuit 203 for each row. The operation of the vertical selection circuit 202 and the horizontal selection circuit 204 is changed as appropriate so that the specific area can be read out. Note that the imaging element 103 includes a timing generator that provides a timing signal to the vertical selection circuit 202, the horizontal selection circuit 204, the read-out circuit 203, and the like, a control circuit, and the like in addition to the components shown in FIGS. 2A and 2B, but no detailed description thereof will be given.

FIG. 2B is a diagram illustrating an exemplary configuration of a pixel portion of the imaging element 103. A pixel portion 300 shown in FIG. 2B has a micro lens 301 serving as an optical element and a plurality of photodiodes (hereinafter abbreviated as “PD”) 302a to 302d serving as light receiving elements. The PD functions as a photoelectric conversion unit that receives a light flux and photoelectrically converts the light flux to thereby generate an image signal. Although, in the example shown in FIG. 2B, the number of PDs provided in one pixel portion is four, the number of PDs may be any number of two or more. Note that the pixel portion also includes a pixel amplifier for reading a PD signal to the read-out circuit 203, a selection switch for selecting a row, a reset switch for resetting a PD signal, and the like in addition to the components shown in FIG. 2B.

The PD 302a and the PD 302c photoelectrically convert the received light flux to thereby output a left image signal. The PD 302b and the PD 302d photoelectrically convert the received light flux to thereby output a right image signal. In other words, among a plurality of PDs included in one pixel portion, an image signal output by right-side PDs is a right image signal and an image signal output by left-side PDs is a left image signal.

When the imaging apparatus of the present embodiment is configured such that a user views a stereoscopic image, image data corresponding to a left image signal functions as image data for left eye which is viewed by a user with his left eye. Also, image data corresponding to a right image signal functions as image data for right eye which is viewed by a user with his right eye. When the imaging apparatus 100 is configured such that a user views image data for left eye with his left eye and views image data for right eye with his left eye, the user can view a stereoscopic image. The imaging apparatus may select and add outputs from a plurality of PDs. For example, the imaging apparatus may add PD outputs from the PD 302a and the PD 302c and PD outputs from the PD 302b and the PD 302d, respectively, so as to obtain two outputs. Note that the pixel portion 300 also includes a pixel amplifier for extracting a PD signal to the read-out circuit 303, a row selection switch, and a reset switch for resetting a PD signal in addition to the components shown in FIG. 2B.

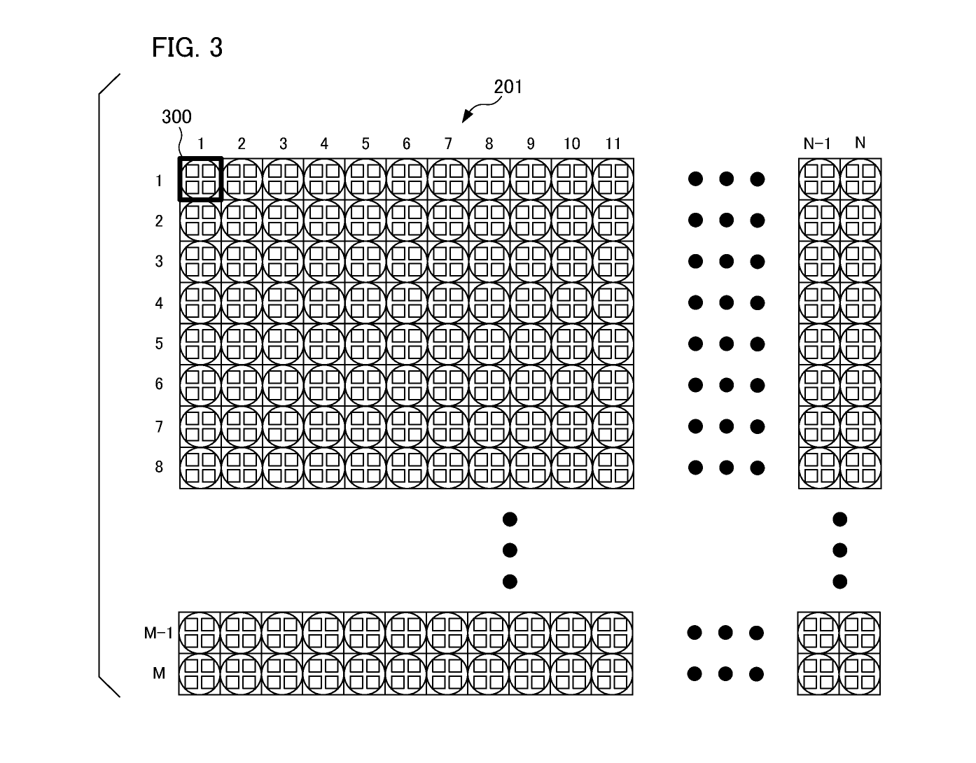

FIG. 3 is a diagram illustrating an exemplary pixel array. As shown in FIG. 3, the pixel array 201 is arranged in a two-dimensional plural array of “N” pixel portions in the horizontal direction and “M” pixel portions in the vertical direction to provide a two-dimensional image. Each of the pixel portions 300 in the pixel array 201 has a color filter. In this example, an odd row is a repetition of a red (R) and a green (G) color filters, and an even row is a repetition of a green (G) and a blue (B) color filters. In other words, the pixel portions provided in the pixel array 301 are arranged in a predetermined pixel array (in this example, Bayer array).

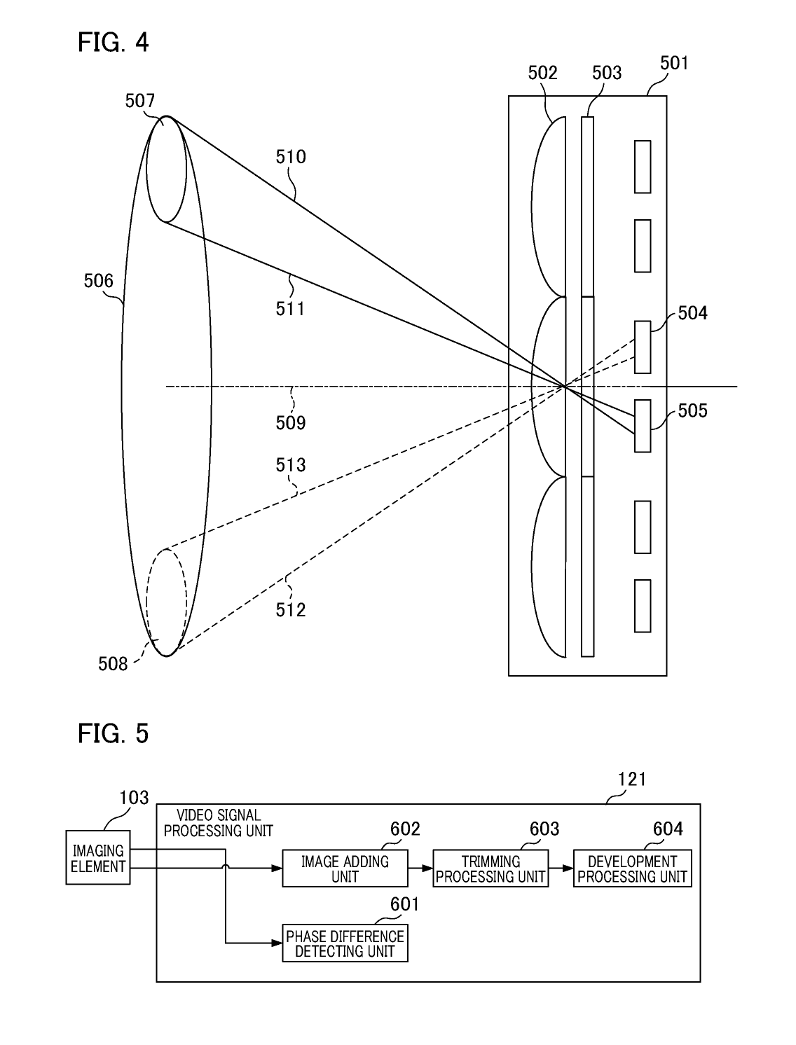

Next, a description will be given of the light receiving of an imaging element having the pixel configuration shown in FIG. 3. FIG. 4 is a conceptual diagram illustrating how a light flux emitted from the exit pupil of a photographing lens enters the imaging element. Reference number 501 denotes the cross-section of three pixel arrays. Each pixel array has a micro lens 502, a color filter 503, and PDs 504 and 505. The PD 504 corresponds to the PD 302a shown in FIG. 2B. Also, the PD 505 corresponds to the PD 302b shown in FIG. 2B.

Reference number 506 denotes the exit pupil of a photographing lens. In this example, the center axis of the light flux emitted from an exit pupil 506 to a pixel portion having the micro lens 502 is defined as an optical axis 509. Light emitted from the exit pupil 506 enters the imaging element 103 about the optical axis 509. Each of reference numbers 507 and 508 denotes the partial area of the exit pupil of the photographing lens. Partial areas 507 and 508 are the different divided areas of the exit pupil of an imaging optical system.

Light beams 510 and 511 are the outermost peripheral light beams of light passing through the partial area 507. Light beams 512 and 513 are the outermost peripheral light beams of light passing through the partial area 508. Among the light fluxes emitted from the exit pupil, the upper light flux enters the PD 505 and the lower light flux enters the PD 504 with the optical axis 509 as the boundary. In other words, each of the PDs 504 and 505 has properties of receiving light emitted from different areas of the exit pupil of the photographing lens.

The imaging apparatus 100 can acquire at least two images with a parallax by making use of such properties. For example, the imaging apparatus 100 acquires a left image signal obtained from a plurality of left-side PDs and a right image signal obtained from a plurality of right-side PDs as a first line and a second line, respectively, in an area in a pixel portion. Then, the imaging apparatus 100 detects a phase difference between these two image signals to thereby realize a phase difference AF (Auto Focus).

From the aforementioned description, the imaging element 103 is an imaging element in which a plurality of pixel portions each having a plurality of PDs which generate an image signal by photoelectrically converting light fluxes having passed through different areas of the exit pupil of an imaging optical system with respect to one micro lens are arranged in the horizontal direction and in the vertical direction.

Referring back to FIG. 1, a video signal processing unit 121 generates display image data based on an image signal output by the imaging element 103.

FIG. 5 is a diagram illustrating an exemplary configuration of a video signal processing unit. The video signal processing unit 121 includes a phase difference detecting unit 601, an image adding unit 602, a trimming processing unit 603, and a development processing unit 604. The phase difference detecting unit 601 detects a phase difference between a left image signal and a right image signal which are output from the readout area of the pixel portion provided in the imaging element 103 and then outputs the detection result to a memory 132. The readout area is an area at which an image single is read out from the pixel portion.

Also, the phase difference detecting unit 601 outputs the reliability of the calculated phase difference. The phase difference detecting unit 601 may also output the detection result to the internal memory of the phase difference detecting unit 601 instead of the memory 132. In other words, the phase difference detecting unit 601 functions as a detecting unit that detects a phase difference between a left image signal and a right image signal which are included in an image single read out from the readout area and then outputs the detected phase difference and the reliability of the phase difference. More specifically, the phase difference detecting unit 601 detects a phase difference between a left image signal and a right image signal which are included in a one-line image signal in the horizontal direction of the set readout area. The reliability corresponds to similarity between a left image signal and a right image signal. The reliability increases with increase in similarity between a left image signal and a right image signal.

The image adding unit 602 applies additive synthesis of a right image signal and a left image signal and then outputs the resulting signal as one image data. The trimming processing unit 603 executes processing (trimming processing) for cutting away a portion of image data output by the image adding unit 602. In the present embodiment, the trimming processing unit 603 performs trimming processing by setting an area other than the area for use in generating a display image, which is included in the readout area, as a trimming target. The development processing unit 604 executes processing such as white balance, color interpolation, color correction, y conversion, edge emphasis, resolution conversion, image compression, and the like for the trimming processing result (digital image data) output by the trimming processing unit 603. In this manner, display image data is generated.

Referring back to FIG. 1, the memory 132 stores display image data output by the video signal processing unit 121. Also, the memory 132 temporarily stores data for use when a CPU 105 performs various types of processing. A timing generator 143 provides timing to the imaging element 103 and the video signal processing unit 121. The lens drive unit 141, the shutter drive unit 142, the imaging element 103, the timing generator 143, the video signal processing unit 121, a CPU 131, a power source 110, the memory 132, and a display control device 151 are connected to a bus 150. Also, a main switch 161, a first release switch 162, a second release switch 163, a live-view start/end button 164, an AF start/end button 165, a up-down and right-left selection button 166, a select button 167, and a card input/output unit 171 are connected to the bus 150.

The CPU 131 controls the entire imaging apparatus 100. For example, the CPU 131 controls the image signal read-out processing performed by the imaging element 103 and the operation timing of the video signal processing unit 121 and the memory 132. The display control device 151 drives and controls a TFT 152 consisting of a liquid crystal display element, a VIDEO output terminal 153, and an HDMI terminal. Also, the display control device 151 outputs display image data stored in the memory 132 to a display device in accordance with an instruction given by the CPU 131. The display image data area within the memory 132 is referred to as “VRAM”. The display control device 151 outputs VRAM to the TFT 152 to thereby update a display image (executes display update processing).

When a user turns the main switch 161 “ON”, the CPU 131 executes a predetermined program. When a user turns the main switch 161 “OFF”, the CPU 131 executes a predetermined program and sets a camera in a stand-by mode.

The first release switch 162 is turned “ON” by the first stroke (half-pressed state) of a release button. The second release switch 163 is turned “ON” by the second stroke (full-pressed state) of the release button. Also, the CPU 131 performs control depending on the operation state of the imaging apparatus 100 in accordance with the pressing of the up-down and right-left selection button 166 and a setting button 167. A user can specify an object to be auto-focused with the up-down and right-left selection button 166 during live-view. A user performs selection and settings on a graphical user interface using the up-down and right-left selection button 166 and the setting button 167 so that live-view photographing can be switchably set to either a normal mode or a zoom mode. The live-view photographing performed when the zoom mode is set is described as “zoom live-view photographing”.

Upon the zoom live-view photographing, an image signal read out from a predetermined readout area of the imaging element 103 is input to the video signal processing unit 121. Also, the CPU 131 performs enlargement processing for image data output by the video signal processing unit 121 in accordance with a predetermined zoom magnification to thereby obtain display image data.

When a user presses the live-view start/end button 164, the CPU 131 captures image data from the imaging element 103 at regular intervals (e.g., 30 times per 1 sec), and arranges the captured image data in a VRAM. In this manner, an image captured from the imaging element 103 can be displayed in real-time. When a user presses the live-view start/end button 164 in a state where the live-view is active, the CPU 131 ends the live-view state. When a user presses the AF start/end button 165, the imaging apparatus 100 starts the auto-focus operation. In other words, the AF start/end button 165 functions as an instructing unit that instructs the execution start of auto-focus adjustment processing. A method for controlling the imaging apparatus of the present embodiment is realized by the functions of the processing units provided in the imaging apparatus 100 shown in FIG. 1.

### First Embodiment

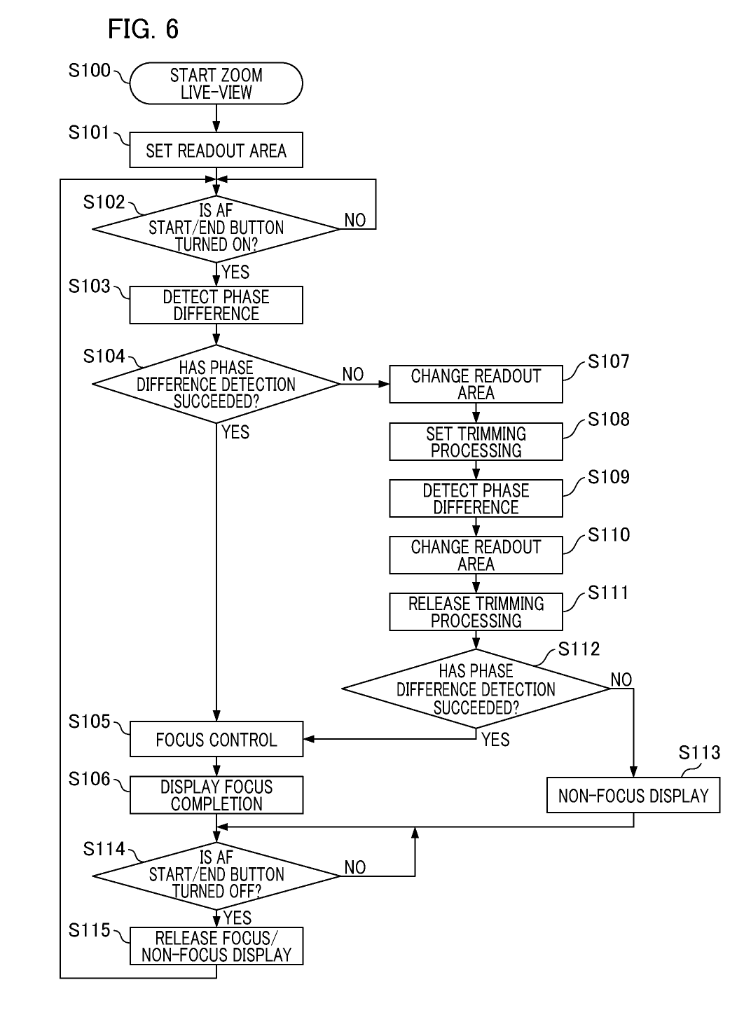

FIG. 6 is a flowchart illustrating an example of operation processing performed by an imaging apparatus according to a first embodiment. The CPU 131 detects pressing of the live-view start/end button 164 to thereby start zoom live-view photographing (step S100). Next, the CPU 131 functions as a setting unit that sets a readout area (step S101).

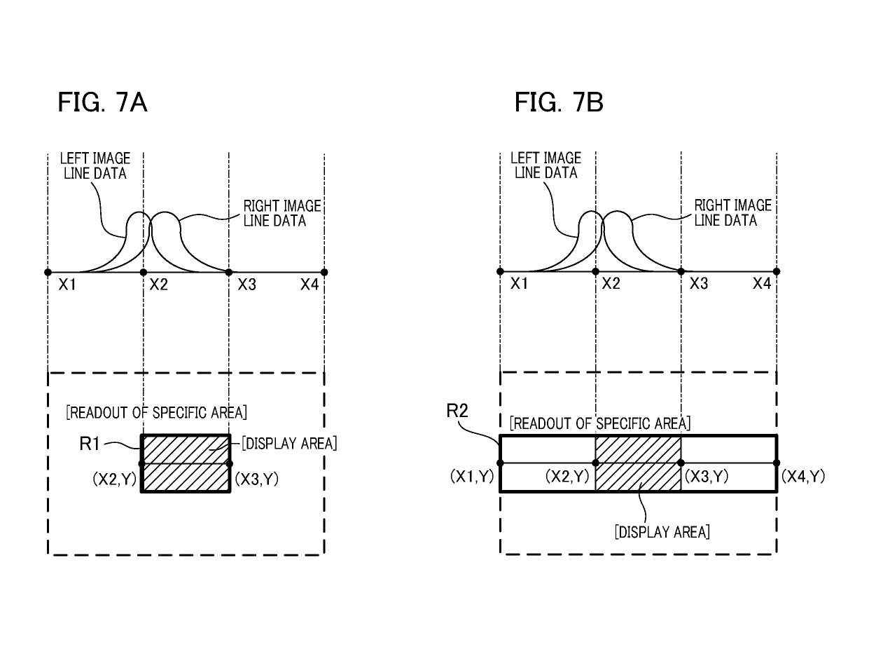

FIG. 7 is a diagram illustrating readout area settings. An area R1 enclosed with a thick line shown in FIG. 7A is a readout area (first readout area) set in step S101. The readout area R1 is an area corresponding to the section between X2 and X3 in the horizontal direction on the imaging element. A display area is an area for generating display data. In the present embodiment, the display area coincides with the readout area R1. Of course, the display area may also be set to an area which is included in the readout area R1 and is smaller than the readout area R1.

Next, the CPU 131 determines whether or not the AF start/end button 165 is turned ON (step S102). When the AF start/end button 165 is not turned ON, the process returns to step S102 again.

The AF start/end button 165 functions as an instructing unit that instructs start of focus adjustment processing. When the AF start/end button 165 is turned ON, it means that execution start of auto-focus adjustment processing has been instructed. Thus, when the AF start/end button 165 is turned ON, the phase difference detecting unit 601 detects a phase difference between a left image signal and a right image signal that are read out from the readout area set in step S101 and then stores the phase difference and its reliability as the output result in the memory 132. Then, the process advances to step S103.

In step S103, the CPU 131 reads out the output result of the phase difference detecting unit 601 from the memory 132 (step S103). The output result of the phase difference detecting unit 601 includes a phase difference calculated from line data in the section between (X2, Y) and (X3, Y) shown in FIG. 7A.

Next, the CPU 131 determines whether or not phase difference detection has been successful based on the reliability of the phase difference included in the output result of the phase difference detecting unit 601 (step S104). When the reliability of the phase difference exceeds a threshold value, the CPU 131 determines that phase difference detection has been successful. When the reliability of the phase difference is equal to or less than a threshold value, the CPU 131 determines that phase difference detection has been unsuccessful. When the CPU 131 determines that phase difference detection has been successful, the process advances to step S105. Then, the CPU 131 calculates the focus control amount of the imaging lens 101 based on the detected phase difference and then performs focus control through the lens drive unit 141 (step S105). In other words, the CPU 131 functions as an adjusting unit that executes focus adjustment processing based on the detected phase difference.

After completion of focus control, the process advances to step S106. Then, the CPU 131 displays the completion of the focus on the TFT 152 through the display control device 151 (step S106), and the process advances to step S114.

When the CPU 131 determines that phase difference detection has been unsuccessful, the process advances to step S107. Then, the CPU 131 changes the readout area from the first readout area set in step S101 to the second readout area (step S107). The CPU 131 sets the second readout area such that the second readout area has a range wider than that of the first readout area and the changed second readout area includes display area included in the first readout area prior to change. In other words, as shown in, for example, FIG. 7B, the CPU 131 sets the readout area R2 corresponding to the section between X1 and X4, which is wider than the section between X2 and X3 in the horizontal direction, as a readout area targeted for detection processing for detecting the next phase difference.

Next, in step S108, the CPU 131 changes the settings made by the trimming processing unit 603 so as to be equal to the display area set in step S101. More specifically, the CPU 131 sets an area other than an area corresponding to the readout area (display area) R1 from among the readout area R2 shown in FIG. 7B as a trimming target. In this manner, it is possible not to change the field angle of an image displayed on the TFT 152.

Referring back to FIG. 6, the phase difference detecting unit 601 detects a phase difference based on the readout area changed in step S107 and outputs the reliability of the phase difference to thereby store the output result in the memory 132 (step S108). Next, the CPU 131 reads out the output result of the phase difference detecting unit 601 from the memory 132.

In step S110, the CPU 131 returns the readout area back to the readout area set in step S101. Then, the CPU 131 releases settings of trimming processing implemented in step S108 (step S111).

Next, the CPU 131 determines whether or not phase difference detection has been successful as in the same method as determination processing in step S104 based on the output result of the phase difference detecting unit 601 read out in step S109 (step S112). When phase difference detection has been successful, the process advances to step S105. When phase difference detection has been unsuccessful, the process advances to step S113.

When it is determined by determination processing in step S112 that phase difference detection has been successful, the process advances to step S105. When it is determined by determination processing in step S112 that phase difference detection has been unsuccessful, the process advances to step S113. Then, the CPU 131 performs non-focus display indicating that the focused state cannot be reached on the TFT 152 through the display control device 151 (step S113), and the process advances to step S114.

In step S114, the CPU 131 determines whether or not the AF start/end button 165 is turned OFF (step S114). When the AF start/end button 165 is not turned OFF, the process returns to step S114. When the AF start/end button 165 is turned OFF, the process advances to step S115. Then, the CPU 131 releases display (focus completion display or non-focus display) displayed on the TFT 152 (step S115), and the process returns to step S102.

According to the imaging apparatus of the first embodiment, an auto-focus operation can be realized while ensuring the phase difference detection accuracy upon phase difference detection in a partial read-out live-view mode.

### Second Embodiment

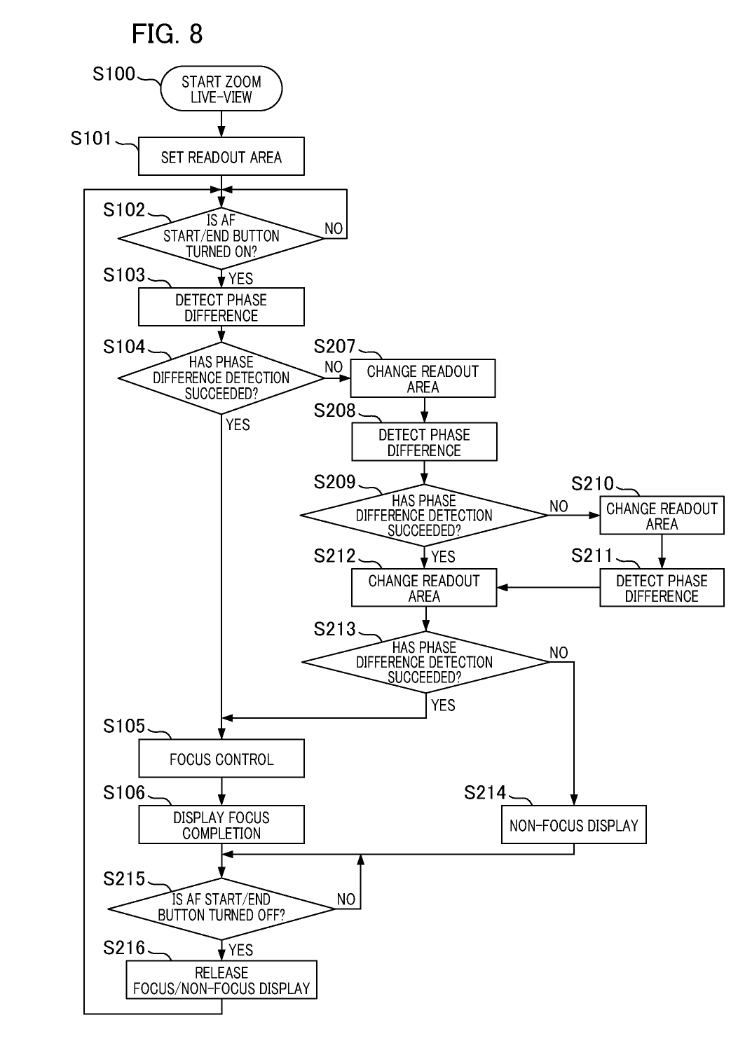

FIG. 8 is a flowchart illustrating an example of operation processing performed by an imaging apparatus according to a second embodiment. In the present embodiment, steps S100 to S106 are the same as those in the first embodiment, and thus, the detailed description thereof will be omitted.

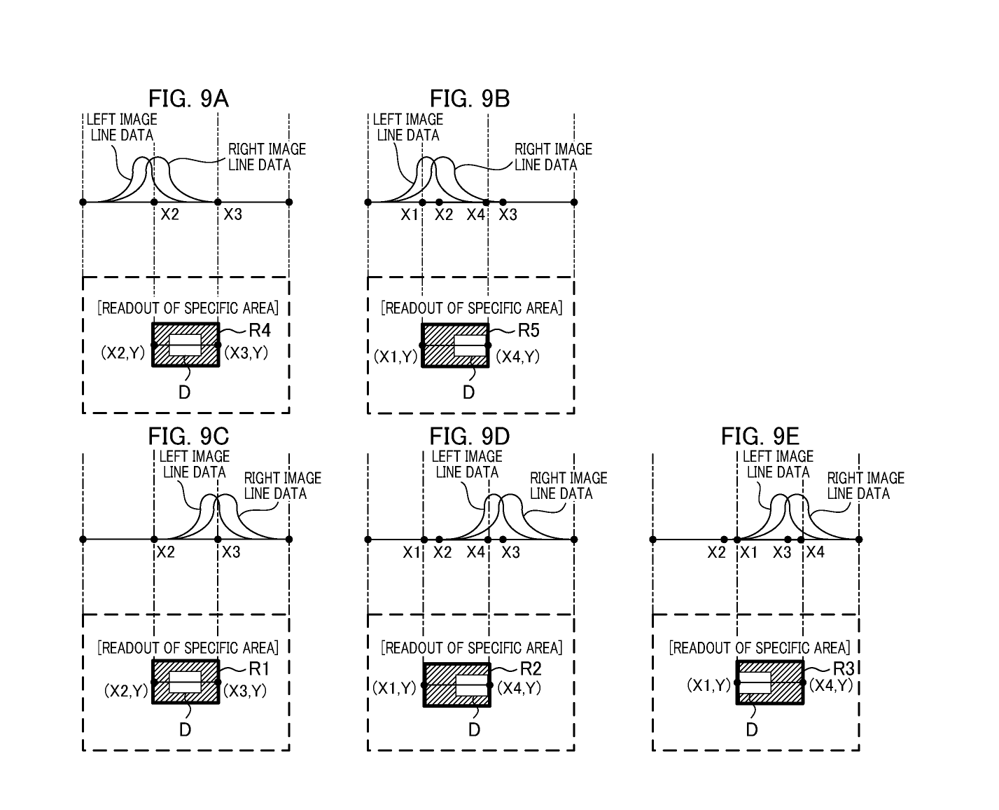

FIGS. 9A to 9E are diagrams illustrating readout area settings. The area R1 enclosed with a thick line shown in FIG. 9C is a readout area set in step S101. Note that the CPU 131 may also set the area R4 enclosed with a thick line shown in FIG. 9A as a readout area. The readout area R1 is an area corresponding to the section between X2 and X3 in the horizontal direction on the imaging element. A display area D is an area for use in generating a display image (e.g., an image for zoom display). In the present embodiment, the display area D is an area that is included in the readout area R1 and is smaller than the readout area R1.

When the CPU 131 determines in step S104 that phase difference detection has been unsuccessful, the process advances to step S207. Then, the CPU 131 changes the readout area from the readout area set in step S101 (step S207). More specifically, the CPU 131 moves the position of the readout area set in step S101 by a predetermined section in the range of the section movable in the left-and-right direction or the up-and-down direction without changing the position of the display area D. In other words, the CPU 131 moves the position of the readout area by a predetermined section such that the display area D falls within the changed readout area. Then, the CPU 131 sets the readout area of which the position has been moved as the next readout area. Next phase difference detection processing is performed based on the image signal from the next readout area.

The CPU 131 changes the readout area, for example, from the readout area R1 shown in FIG. 9C to the readout area R2 shown in FIG. 9D. Also, the CPU 131 changes the readout area, for example, from the readout area R4 shown in FIG. 9A to the readout area R5 shown in FIG. 9B.

Although the width of the readout area R2 shown in FIG. 9D in the horizontal direction is the same as that of the readout area R1 in the horizontal direction, the readout area R2 corresponds to the section between X1 and X4 in the horizontal direction. In other words, the readout area R2 moves in the left direction (first direction) from the position of the readout area R1. In this example, the right end of the display area D coincides with the right end of the changed readout area R2, but the right end of the display area D may not coincide with the right end of the changed readout area R2.

Although the width of the readout area R5 shown in FIG. 9B in the horizontal direction is the same as that of the readout area R4 in the horizontal direction, the readout area R5 corresponds to the section between X1 and X4 in the horizontal direction. In other words, the readout area R5 moves in the left direction from the position of the readout area R4. In this example, the right end of the display area D coincides with the right end of the changed readout area R5, but the right end of the display area D may not coincide with the right end of the changed readout area R5.

Referring back to FIG. 8, the phase difference detecting unit 601 detects a phase difference based on the readout area changed in step S207 and then outputs the reliability of the phase difference to thereby store the output result in the memory 132 (step S208). Next, the CPU 131 reads out the output result of the phase difference detecting unit 601 from the memory 132. Then, the CPU 131 determines whether or not phase difference detection has been successful as in the same method as determination processing in step S104 based on the output result of the phase difference detecting unit 601 (step S209). When phase difference detection has been successful, the process advances to step S212. When phase difference detection has been unsuccessful, the process advances to step S210.

In step S210, the CPU 131 changes the readout area. More specifically, the CPU 131 moves the position of the readout area set in step S101 by a predetermined section in the movable range of the section without changing the position of the display area D. The CPU 131 moves the readout area in the direction (second direction) opposite to the direction of movement of the readout area in step S207.

For example, it is assumed that a readout area targeted for phase difference detection has been changed from the readout area R1 (FIG. 9C) to the readout area R2 (FIG. 9D) in step S207. In step S210, the CPU 131 sets a readout area targeted for phase difference detection to, for example, the readout area R3 shown in FIG. 9E. Although the width of the readout area R3 in the horizontal direction is the same as that of the readout area R1 in the horizontal direction, the readout area R3 has moved from the position of the readout area R1 by a predetermined section in the right direction.

Referring back to FIG. 8, in step S211, the phase difference detecting unit 601 detects a phase difference based on the readout area changed in step S207 and then outputs the reliability of the phase difference to thereby store the output result in the memory 132 (step S211). Next, the CPU 131 reads out the output result of the phase difference detecting unit 601 from the memory 132. Next, the CPU 131 set a readout area targeted for phase difference detection to the readout area set in step S101 again (step S212). Then, the CPU 131 determines whether or not phase difference detection has been successful (step S213).

A description will be given of determination processing in step S213. When the CPU 131 determines that phase difference detection has been successful in step S209, the CPU 131 determines in step S213 that phase difference detection has been successful. When phase difference detection has been successful in step S209 and the readout area has been changed in step S210, the CPU 131 determines whether or not phase difference detection has been successful based on the output result output by the phase difference detecting unit 601 in step S211. The determination processing in this case is performed by the same method as determination processing in steps S104 and S209.

When it is determined by determination processing in step S213 that phase difference detection has been successful, the process advances to step S105. When it is determined by determination processing in step S213 that phase difference detection has been unsuccessful, the process advances to step S214. Then, the CPU 131 performs non-focus display indicating that the focused state cannot be reached on the TFT 152 through the display control device 151 (step S214), and the process advances to step S215.

In step S215, the CPU 131 determines whether or not the AF start/end button 165 is turned OFF (step S215). When the AF start/end button 165 is not turned OFF, the process returns to step S215. When the AF start/end button 165 is turned OFF, the process advances to step S216. Then, the CPU 131 releases display (focus completion display or non-focus display) displayed on the TFT 152 (step S216), and the process returns to step S102.

According to the imaging apparatus of the second embodiment, an auto-focus operation can be realized while ensuring the phase difference detection accuracy upon phase difference detection in a partial read-out live-view mode.

### Third Embodiment

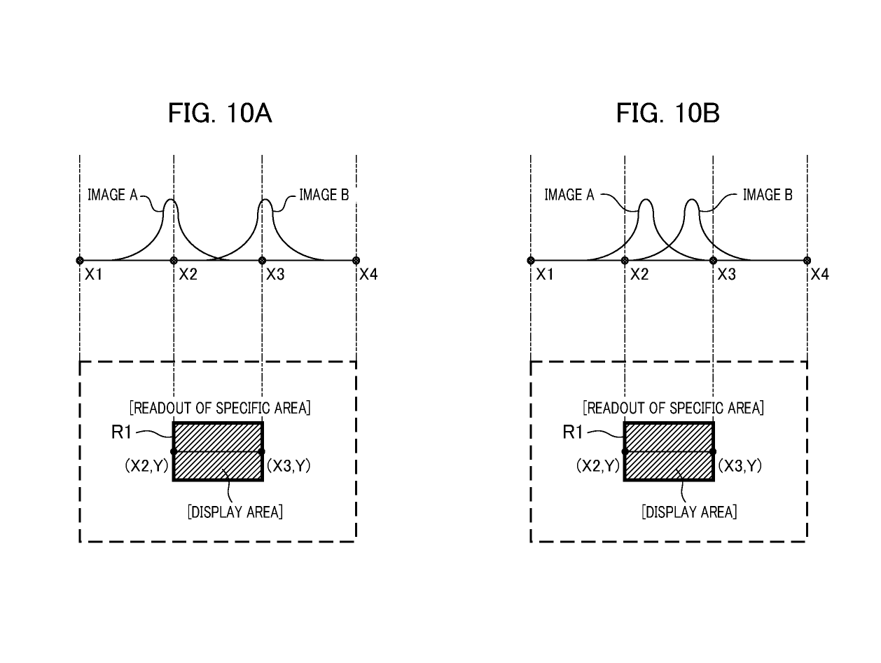

Next, a description will be given of an imaging apparatus according to a third embodiment. The flowchart illustrating an example of operation processing performed by the imaging apparatus according to the third embodiment is the same as that shown in FIG. 6, and thus, the detailed description thereof will be omitted. FIGS. 10A and 10B are diagrams illustrating readout area settings. The left image signal and the right image signal shown in FIG. 10A are a left image signal and a right image signal, respectively, upon setting the readout area in step S101 shown in FIG. 6. In the example shown in FIG. 10A, the phase difference between the left image signal and the right image signal is large, so that the image is out-of-focus.

The CPU 131 determines the aperture amount of the lens to a predetermined aperture amount and sets the aperture amount to the lens drive unit 141. The CPU 131 holds the aperture value (F-number) prior to setting the aperture amount in the memory 132. The CPU 131 may also set the aperture amount in one stage or in two stages. Note that the CPU 131 determines the aperture amount so as not to affect the accuracy of the phase difference detecting unit 601 by restricting the aperture of the imaging lens 101. This is because, if the aperture of the imaging lens 101 is restricted too much, an image becomes too dark, resulting in a degradation in the accuracy of the phase difference detecting unit 601. Thus, the CPU 131 sets the aperture amount of the lens in a range such that the reliability of the phase difference output by phase difference detection processing is not equal to or not less than a threshold value.

Furthermore, in step S108 shown in FIG. 6, the lens drive unit 141 restricts the aperture of the imaging lens 101 by the aperture amount determined in step S107 (performs lens restriction drive). In other words, the CPU 131 functions as a control unit that restricts the aperture of the imaging lens 101 by providing an instruction to the lens drive unit 141 depending on the reliability of the output phase difference. Then, the phase difference detecting unit 601 detects a phase difference based on an image signal read out from the readout area after completion of lens restriction drive in step S108 and then outputs the reliability of the phase difference to thereby store the output result in the memory 132 (step S108). In other words, the phase difference detecting unit 601 performs phase difference detection again in a state where the aperture of the imaging lens 101 is restricted to thereby output the reliability of the phase difference again. Then, the CPU 131 reads out the output result of the phase difference detecting unit 601 from the memory 132.

By performing lens aperture drive in step S108, a phase difference between a left image signal and a right image signal that are read out from the readout area becomes small as shown in FIG. 10B. In other words, the depth of field is deep by restricting the aperture of the lens, so that the image is slightly in focus. In this manner, the reliability of the phase difference increases, resulting in an increase in the phase difference detection accuracy.

Then, the CPU 131 sets the aperture value held in the memory in step S107 to the lens drive unit 141 again. In other words, the CPU 131 returns the lens aperture value back to the aperture value prior to the re-output of the reliability of the phase difference. In step S111, the lens drive unit 141 drives the imaging lens 101 with the aperture value set in step S110.

In the present embodiment, after detection of the phase difference in step S109, the aperture amount of the lens is returned to the previous state in steps S110 and S111 and then focus control is performed in step S105. Of course, the of aperture amount of the lens may also be returned to the previous state in steps S110 and S111 after completion of focus control in step S105.

According to the imaging apparatus of the third embodiment, an auto-focus operation can be realized while ensuring the phase difference detection accuracy upon phase difference detection in a partial read-out live-view mode.

### Fourth Embodiment

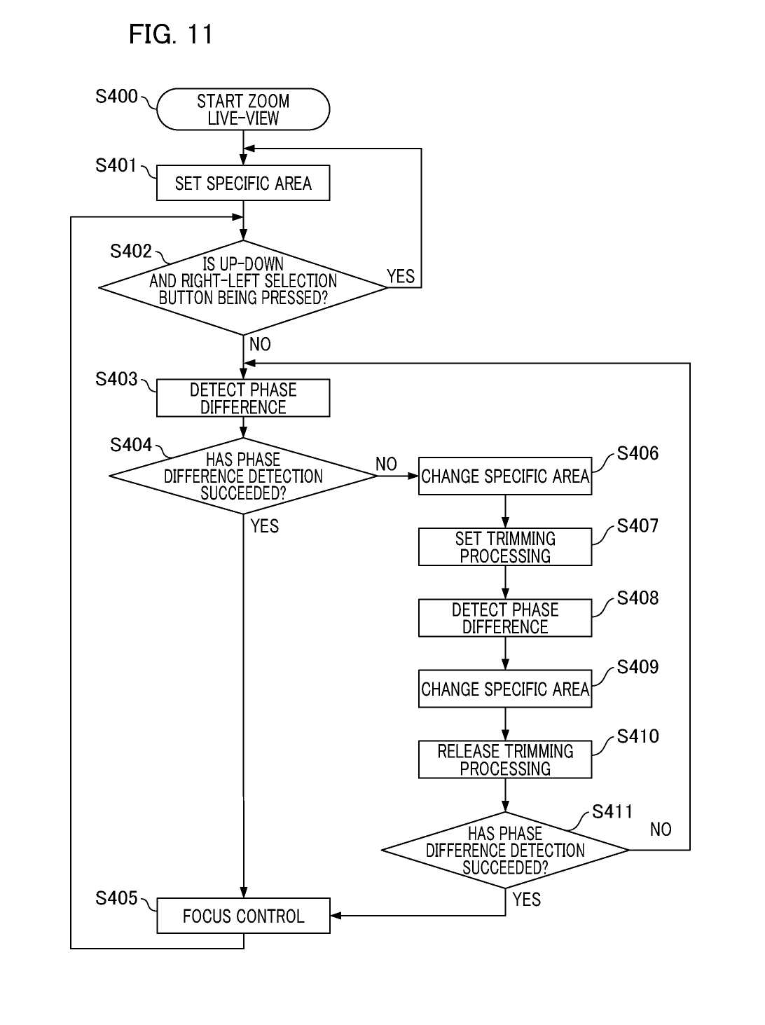

FIG. 11 is a flowchart illustrating an example of operation processing performed by an imaging apparatus according to a fourth embodiment. The CPU 131 detects pressing of the live-view start/end button 164 to thereby start zoom live-view photographing (step S400). Next, the CPU 131 functions as a setting unit that sets a specific area (step S401).

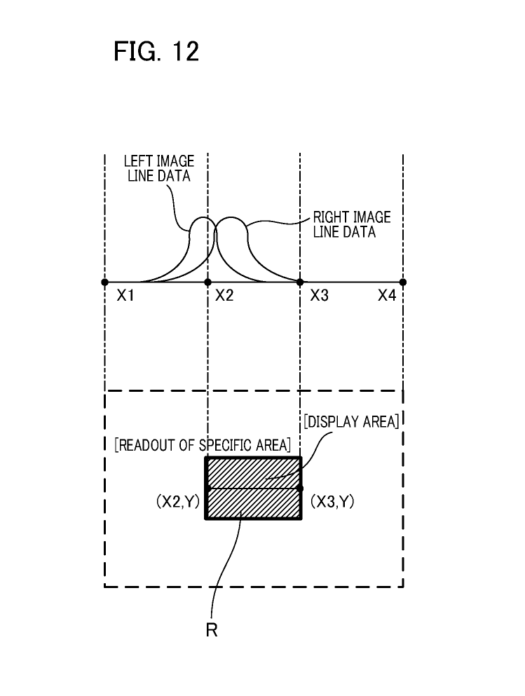

FIG. 12 is a diagram illustrating specific area settings. An area R enclosed with a thick line shown in FIG. 12 is a specific area set in step S401. The specific area R is an area corresponding to the section between X2 and X3 in the horizontal direction on the imaging element. A display area which is an area subjected to hatching is an area for generating display data. In the example shown in FIG. 12, the display area coincides with the specific area R. Of course, the display area may also be set to an area which is included in the specific area R and is smaller than the specific area R. The CPU 131 performs control such that reading out from an area other than a specific area is skipped by the vertical selection circuit 202 and the horizontal selection circuit 204.

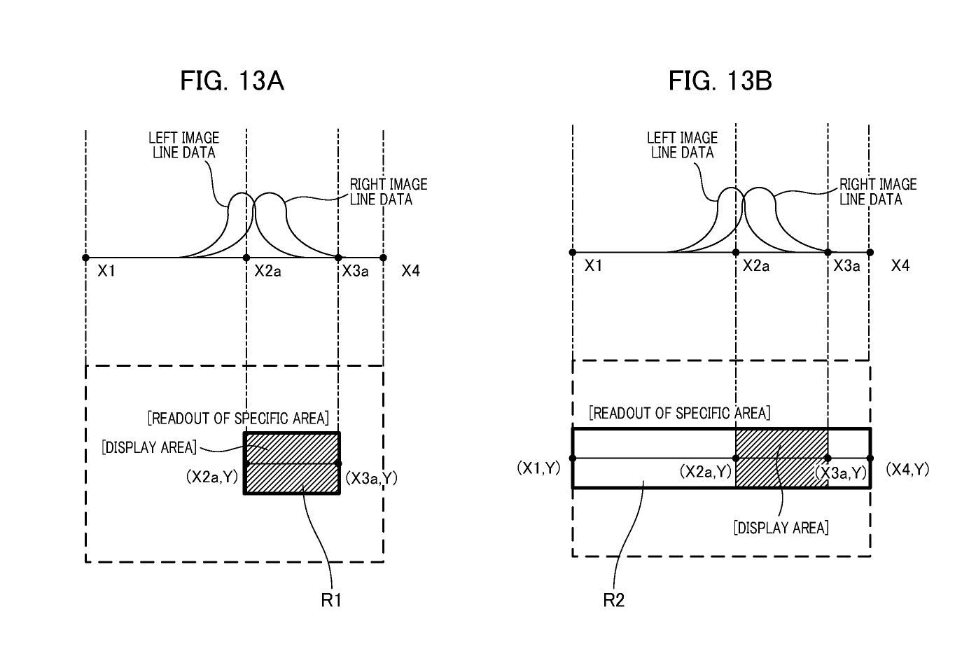

Next, the CPU 131 determines whether or not a zoom live-view display position has been changed by the pressing of the up-down and right-left selection button 166 (step S402). When the display position has been changed, the process returns to step S401, and the CPU 131 resets the specific area of the imaging element 103. More specifically, as shown in FIG. 13A, the CPU 131 sets the specific area to a first specific area (the specific area R1) having a range of from X2a to X3a. The CPU 131 captures image data corresponding to the changed display position from the imaging element 103 and arranges the captured image data in a VRAM.

When the display position has not been changed, that is, when the operation of the up-down and right-left selection button 166 has been completed, the phase difference detecting unit 601 detects a phase difference between two images (left image signal and right image signal) read out from the specific area R1 set in step S401. The phase difference detecting unit 601 stores the phase difference and its reliability as the output result in the memory 132. Then, the process advances to step S403.

In step S403, the CPU 131 reads out the output result of the phase difference detecting unit 601 from the memory 132 (step S403). Next, the CPU 131 determines whether or not phase difference detection has been successful based on the reliability of the phase difference included in the output result of the phase difference detecting unit 601 (step S404). When the reliability of the phase difference exceeds a threshold value, the CPU 131 determines that phase difference detection has been successful. When the reliability of the phase difference is equal to or less than a threshold value, the CPU 131 determines that phase difference detection has been unsuccessful. When the CPU 131 determines that phase difference detection has been successful, the process advances to step S405. Then, the CPU 131 calculates the focus control amount of the imaging lens 101 based on the detected phase difference and then performs focus control through the lens drive unit 141 (step S405), and the process returns to step S402. In other words, the CPU 131 functions as an adjusting unit that executes focus adjustment processing based on the detected phase difference.

When the CPU 131 determines that phase difference detection has been unsuccessful, the process advances to step S407. Then, the CPU 131 changes the specific area from the first readout area set in step S401 to the second readout area having a range wider than that of the first specific area (step S407). More specifically, as shown in, for example, FIG. 13B, the CPU 131 sets the specific area R2 corresponding to the section between X1 and X4, which is wider than the section of the specific area R1 shown in FIG. 13A in the horizontal direction, as a specific area targeted for detection processing for detecting the next phase difference. The specific area R2 is the entire area in the horizontal direction (the X direction) having a predetermined width in the vertical direction (the Y direction) from among the area of the whole field angle of the imaging element. The CPU 131 performs control such that reading out from an area other than a specific area is skipped by the vertical selection circuit 202 and the entire horizontal line is read out by the horizontal selection circuit 204.

Note that the CPU 131 may also cause the horizontal selection circuit 204 to read out an image signal from the specific area R2 by thinning out a predetermined horizontal line.

Next, in step S408, the CPU 131 changes the settings made by the trimming processing unit 603 so as to be equal to the display area set in step S401. More specifically, the CPU 131 sets an area other than the display area subjected to hatching from among the specific area R2 shown in FIG. 13B as a trimming target. In this manner, it is possible not to change the field angle of an image displayed on the TFT 152.

Referring back to FIG. 11, the phase difference detecting unit 601 detects a phase difference based on the specific area changed in step S407 and outputs the reliability of the phase difference to thereby store the output result in the memory 132 (step S408). Next, the CPU 131 reads out the output result of the phase difference detecting unit 601 from the memory 132.

In step S410, the CPU 131 returns the specific area back to the specific area set in step S401. Then, the CPU 131 releases settings of trimming processing implemented in step S407 (step S410).

Next, the CPU 131 determines whether or not phase difference detection has been successful as in the same method as determination processing in step S404 based on the output result of the phase difference detecting unit 601 read out in step S408 (step S411). When phase difference detection has been successful, the process advances to step S405. When phase difference detection has been unsuccessful, the process advances to step S403.

When it is determined by determination processing in step S402 that the zoom live-view display position has not been changed as a result of determination as to whether or not the display position has been changed, the CPU 131 may also perform phase difference detection processing in step S403 after elapse of a predetermined time. In this manner, even when a display position is frequently changed by a user, phase difference detection processing is not performed in each case, so that the number of times of occurrence of disturbances of a screen can be reduced by lens drive.

According to the imaging apparatus of the fourth embodiment, even when a partial read-out position is changed in association with change in position of a display area by a user in a partial read-out live view mode, the following effects may be provided. In other words, a continuous auto-focus operation can be realized while ensuring the phase difference detection accuracy without any loss of display image quality.

### Fifth Embodiment

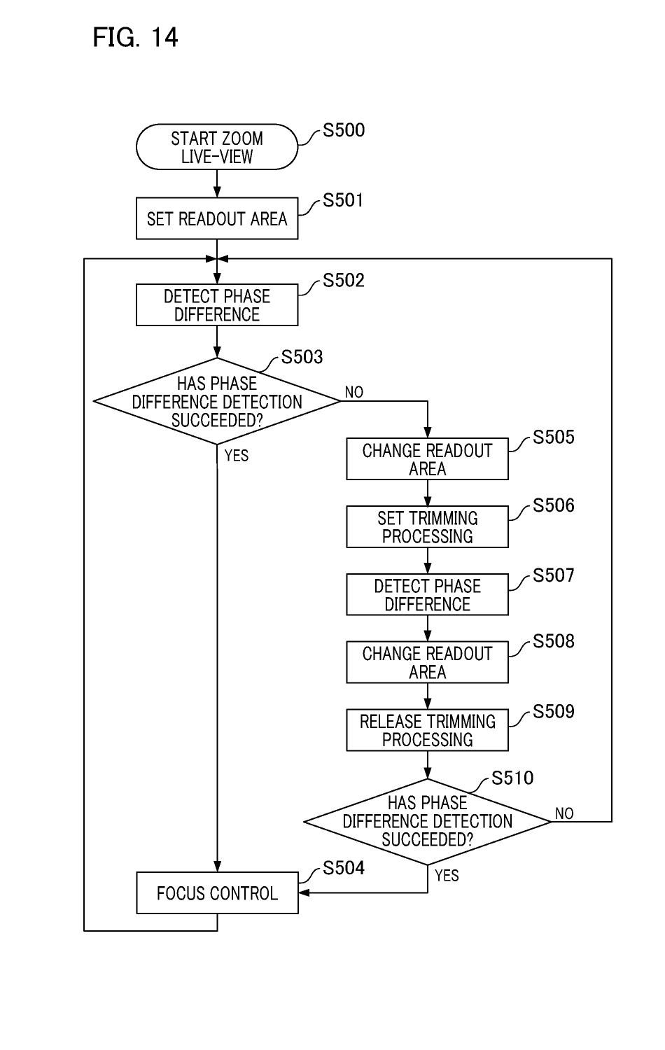

FIG. 14 is a flowchart illustrating an example of operation processing performed by an imaging apparatus according to a fifth embodiment. In the fifth embodiment, the CPU 131 performs phase difference detection processing (step S502) using readout area setting processing (step S501) as a trigger. In other words, unlike the imaging apparatus of the first embodiment, the imaging apparatus of the fourth embodiment performs phase difference detection processing without using the fact that the AF start/end button 165 is turned ON as a trigger.

Steps S500, S501, S502, S503, and S504 shown in FIG. 14 are the same as steps S100, S101, S103, S104, and S105 shown in FIG. 6, respectively. Also, steps S505, S506, S507, S508, S509, and S510 shown in FIG. 14 are the same as steps S107, S108, S109, S110, S111, and S112 shown in FIG. 6, respectively. Note that the process returns to step S502 after processing in step S504. When it is determined by determination processing in step S511 that phase difference detection has been unsuccessful, the process returns to step S502.

According to the imaging apparatus of the fifth embodiment, a continuous auto-focus operation can be realized while ensuring the phase difference detection accuracy upon phase difference detection in a partial read-out live-view mode.

### Sixth Embodiment

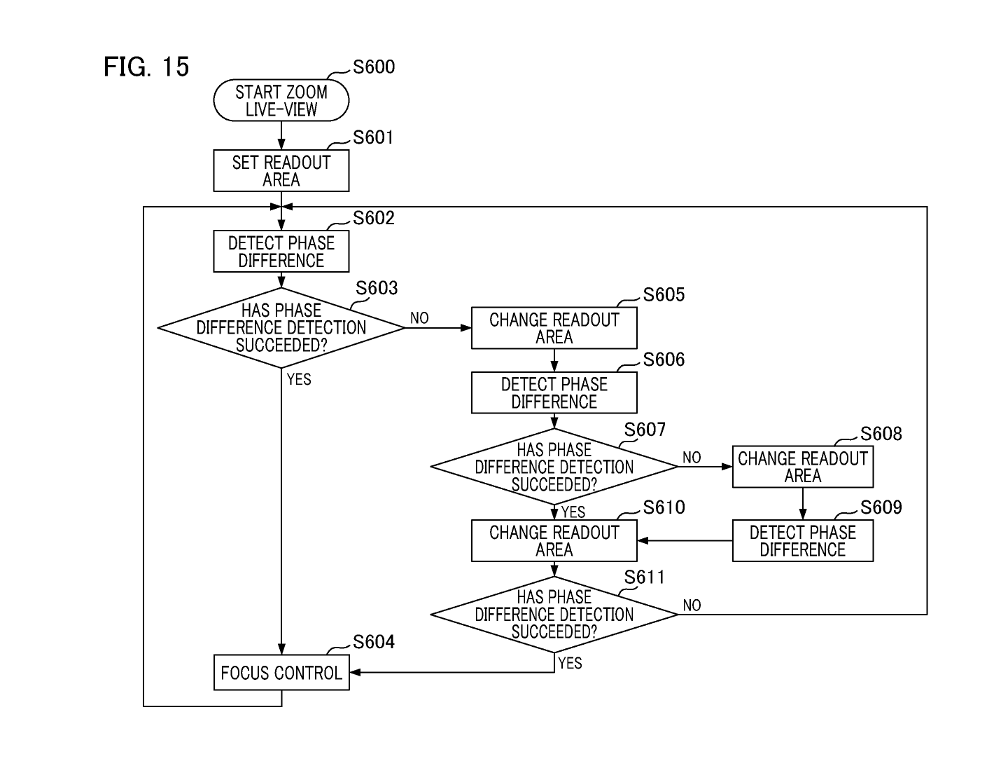

FIG. 15 is a flowchart illustrating an example of operation processing performed by an imaging apparatus according to a sixth embodiment. In the sixth embodiment, the CPU 131 performs phase difference detection processing (step S602) using readout area setting processing (step S601) as a trigger. In other words, unlike the imaging apparatus of the second embodiment, the imaging apparatus of the sixth embodiment performs phase difference detection processing without using the fact that the AF start/end button 165 is turned ON as a trigger.

Steps S600, S601, S602, S603, and S604 shown in FIG. 15 are the same as steps S100, S101, S103, S104, and S105 shown in FIG. 8, respectively. Also, steps S605, S606, S607, S608, S609, S610, and S611 shown in FIG. 15 are the same as steps S207, S208, S209, S210, S211, S212, and S213 shown in FIG. 8, respectively. Note that the process returns to step S602 after processing in step S604. When it is determined by determination processing in step S611 that phase difference detection has been unsuccessful, the process returns to step S602.

According to the imaging apparatus of the sixth embodiment, a continuous auto-focus operation can be realized while ensuring the phase difference detection accuracy without degradation in display frame rate upon phase difference detection in a partial read-out live-view mode.

### Seventh Embodiment

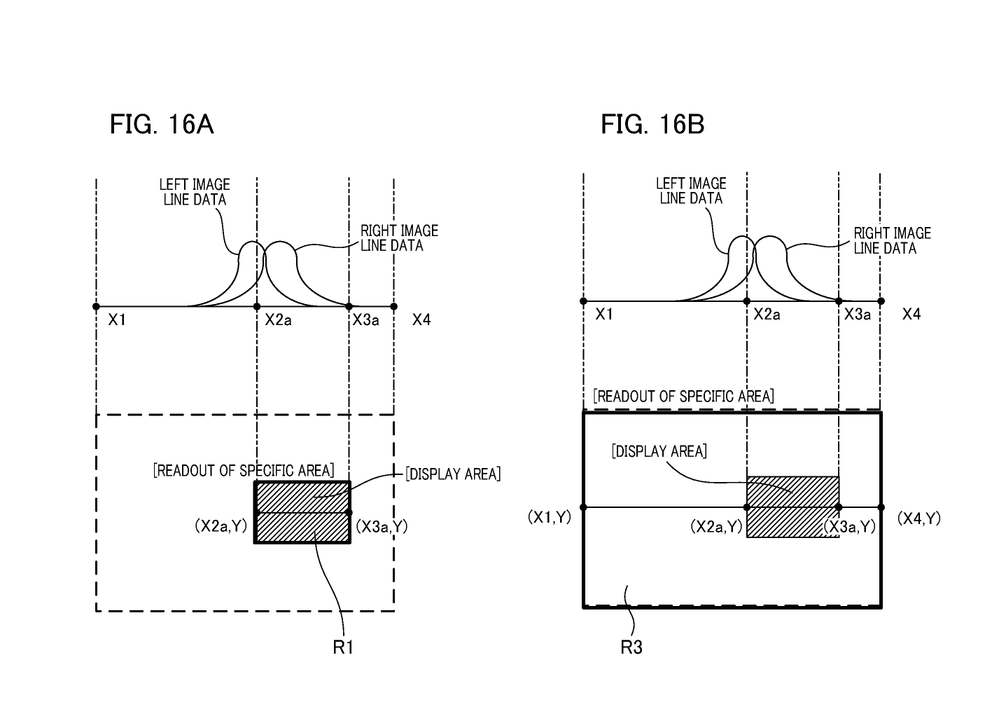

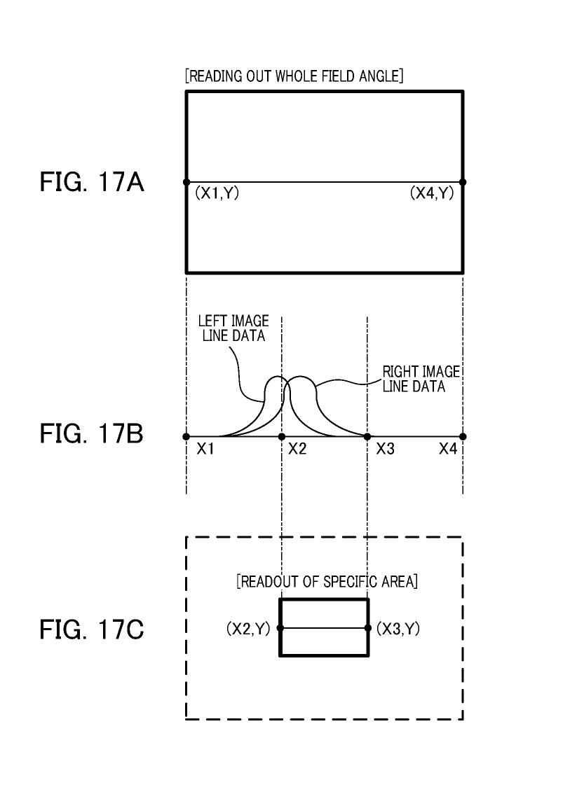

Next, a description will be given of an imaging apparatus according to a seventh embodiment. FIG. 16A is a diagram illustrating the specific area R1 set in step S401 shown in FIG. 11.

In the seventh embodiment, in step S406 shown in FIG. 11, the CPU 131 sets a specific area R3 enclosed with a thick frame shown in FIG. 16B. The specific area R3 has the section between X1 and X4 which is wider than that between X2a and X3a. The specific area R3 may also be the area of the whole field angle of the imaging element. In other words, the specific area R3 has an area which is wider than the specific area R1 in both X and Y directions. At this time, the CPU 131 causes the vertical selection circuit 202 or the horizontal selection circuit 204 to read out an image signal from the specific area R3 by thinning out a predetermined line included in the specific area R3. For example, the CPU 131 causes the vertical selection circuit 202 to read out an image signal from the specific area R3 by thinning out a predetermined horizontal line (row). The CPU 131 may also causes the horizontal selection circuit 204 to read out an image signal from the specific area R3 by thinning out a predetermined vertical line (column).

According to the imaging apparatus of the seventh embodiment, a continuous auto-focus operation can be realized without degradation in frame rate while ensuring the phase difference detection accuracy.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2012-254716 filed on Nov. 20, 2012, Japanese Patent Application No. 2012-248657 filed on Nov. 12, 2012, Japanese Patent Application No. 2012-245309 filed on Nov. 7, 2012, and Japanese Patent Application No. 2013-101182 filed on May 13, 2013, which are hereby incorporated by reference herein in their entirety.

What is claimed is:

1. An imaging apparatus comprising:
an imaging element comprising a pixel portion having a plurality of photoelectric conversion units that are configured to generate an image signal by photoelectrically converting light fluxes having passed through different divided areas of an exit pupil of an imaging optical system with respect to one micro lens;
a setting unit configured to set a first readout area as an area for reading out an image signal from the pixel portion;
a detecting unit configured to perform detection processing for detecting a phase difference between a left image signal and a right image signal that are included in the image signal read out from the first readout area to thereby output a reliability of the phase difference;
a determining unit configured to determine whether or not phase difference detection has been successful based on the reliability of the output phase difference; and
an adjusting unit configured to execute focus adjustment processing based on the detected phase difference if it is determined that phase difference detection has been successful,
wherein, if it is determined that the phase difference has failed to be detected, the setting unit sets a second readout area having a range wider than that of the first readout area as a readout area targeted for detection processing for detecting the next phase difference, and
wherein the imaging apparatus further comprises a trimming processing unit that is configured to perform trimming processing by setting an area other than an area which is included in the first readout area and is used for generating a display image as a trimming target in the second readout area.

2. The imaging apparatus according to claim 1, wherein, after the detecting unit performs detection processing for detecting the phase difference based on the image signal read out from the second readout area to thereby output the reliability of the phase difference, the setting unit returns a readout area targeted for detection processing for detecting the next phase difference from the second readout area to the first readout area, and the trimming processing unit releases settings of the trimming processing.

3. The imaging apparatus according to claim 1, wherein the determining unit determines that phase difference detection has been successful if the reliability of the phase difference exceeds a threshold value, whereas the determining unit determines that the phase difference has failed to be detected if the reliability of the phase difference is equal to or less than a threshold value.

4. The imaging apparatus according to claim 2, wherein the determining unit determines that phase difference detection has been successful if the reliability of the phase difference exceeds a threshold value, whereas the determining unit determines that the phase difference has failed to be detected if the reliability of the phase difference is equal to or less than a threshold value.

5. The imaging apparatus according to claim 1, further comprising:
an instructing unit configured to instruct start of focus adjustment processing,
wherein, when the instructing unit instructs start of focus adjustment processing, the detecting unit performs detection processing for detecting the phase difference to thereby output the reliability of the phase difference.

6. The imaging apparatus according to claim 1, wherein the detecting unit stores the output phase difference and the reliability of the phase difference in a storing unit, and the determining unit determines whether or not phase difference detection has been successful based on the reliability of the phase difference stored in the storing unit.

7. A method for controlling an imaging apparatus that comprises an imaging element comprising a pixel portion having a plurality of photoelectric conversion units that are configured to generate an image signal by photoelectrically converting light fluxes having passed through different divided areas of an exit pupil of an imaging optical system with respect to one micro lens, the method comprising:
setting a first readout area as an area for reading out an image signal from the pixel portion;
performing detection processing for detecting a phase difference between a left image signal and a right image signal that are included in the image signal read out from the first readout area to thereby output the reliability of the phase difference;
determining whether or not phase difference detection has been successful based on the reliability of the output phase difference; and
executing focus adjustment processing based on the detected phase difference if it is determined that phase difference detection has been successful,
wherein, if it is determined that the phase difference has failed to be detected, in setting, a second readout area having a range wider than that of the first readout area is set as a readout area targeted for detection processing for detecting the next phase difference, and
wherein the method further comprises performing trimming processing by setting an area other than an area which is included in the first readout area and is used for generating a display image as a trimming target in the second readout area.

8. An imaging apparatus comprising:
an imaging element comprising a pixel portion having a plurality of photoelectric conversion units that are configured to generate an image signal by photoelectrically converting light fluxes having passed through different divided areas of an exit pupil of an imaging optical system with respect to one micro lens;
a setting unit configured to set a readout area as an area for reading out an image signal from the pixel portion;
a detecting unit configured to perform detection processing for detecting a phase difference between a left image signal and a right image signal that are included in the image signal read out from the readout area to thereby output the reliability of the phase difference;
a determining unit configured to determine whether or not phase difference detection has been successful based on the reliability of the output phase difference; and
an adjusting unit configured to execute focus adjustment processing based on the detected phase difference if it is determined that phase difference detection has been successful,
wherein, if it is determined that the phase difference has failed to be detected, the setting unit sets the readout area as a readout area targeted for detection processing for detecting the next phase difference by changing the position of the readout area without changing the position of an area which is included in the readout area and is used for generating a display image.

9. An imaging apparatus comprising:
an imaging element comprising a pixel portion having a plurality of photoelectric conversion units that are configured to generate an image signal by photoelectrically converting light fluxes having passed through different divided areas of an exit pupil of an imaging optical system with respect to one micro lens;
a setting unit configured to set a readout area as an area for reading out an image signal from the pixel portion;
a detecting unit configured to perform detection processing for detecting a phase difference between a left image signal and a right image signal that are included in the image signal read out from the readout area to thereby output the reliability of the phase difference;
a determining unit configured to determine whether or not phase difference detection has been successful based on the reliability of the output phase difference;
an adjusting unit configured to execute focus adjustment processing based on the detected phase difference if it is determined that phase difference detection has been successful;
a drive unit configured to drive a lens for imaging an object optical image onto the imaging element; and
a control unit configured to instruct the drive unit to restrict the lens depending on the reliability of the phase difference output by the detecting unit when it is determined that the phase difference has failed to be detected.
